(19) United States
(12) Patent Application Publication
(10) Pub. No.: US 2012/0123571 A1
(43) Pub. Date: May 17, 2012

(54) ENHANCED PARIMUTUEL WAGERING

(76) Inventors: Jeffrey Lange, New York, NY (US); Kenneth Charles Baron, New York, NY (US); Charles Walden, Austin, TX (US); Marcus Harte, Bridgewater, NJ (US)

(21) Appl. No.: 13/160,894

(22) Filed: Jun. 15, 2011

Related U.S. Application Data
(63) Continuation-in-part of application No. 12/924,766, filed on Oct. 5, 2010.
Application No. 12/924,766 is a continuation of application No. 12/660,400, filed on Feb. 24, 2010.
Application No. 12/660,400 is a continuation of application No. 10/640,656, filed on Aug. 13, 2003, now Pat. No. 7,742,972.
Application No. 10/640,656 is a continuation-in-part of application No. 10/365,033, filed on Feb. 11, 2003, now Pat. No. 8,126,794.
Application No. 10/365,033 is a continuation-in-part of application No. 10/115,505, filed on Apr. 2, 2002.
Application No. 10/115,505 is a continuation-in-part of application No. 09/950,498, filed on Sep. 10, 2001, now Pat. No. 7,996,296.
Application No. 09/950,498 is a continuation-in-part of application No. 09/809,025, filed on Mar. 16, 2001, now Pat. No. 7,225,153.
Application No. 09/809,025 is a continuation-in-part of application No. 09/744,816, filed on Apr. 3, 2001, now Pat. No. 7,389,262.
Application No. 09/744,816 is a continuation-in-part of application No. 09/448,822, filed on Nov. 24, 1999, now Pat. No. 6,321,212.
(60) Provisional application No. 60/144,890, filed on Jul. 21, 1999.

(51) Int. Cl. G06F 19/00

(52) U.S. Cl. 700/93

(57) ABSTRACT

A wagering system and method may include a processor that presents indicative odds in a parimutuel wagering system to the user such that the user may place a bet of one of the presented bets, besides for a win bet and an exacta bet.

### RELATED APPLICATIONS

This application is a continuation-in-part of U.S. patent application Ser. No. 12/924,766, filed on Oct. 5, 2010; which is a continuation of U.S. patent application Ser. No. 12/660,400, filed on Feb. 24, 2010, which is a continuation of U.S. patent application Ser. No. 10/640,656, filed Aug. 13, 2003; which is a continuation-in-part of U.S. patent application Ser. No. 10/365,033, filed Feb. 11, 2003; which is a continuation-in-part of U.S. patent application Ser. No. 10/115,505, filed Apr. 2, 2002; which is a continuation-in-part of U.S. patent application Ser. No. 09/950,498, filed Sep. 10, 2001; which is a continuation-in-part of U.S. patent application Ser. No. 09/809,025, filed Mar. 16, 2001, which issued as U.S. Pat. No. 7,225,153; which is a continuation-in-part of U.S. patent application Ser. No. 09/744,816, which was attributed a filing date of Apr. 3, 2001 and which issued as U.S. Pat. No. 7,389,262; which was the United States national stage application under 35 U.S.C. §371 of Patent Cooperation Treaty Application No. PCT/US00/19447, filed Jul. 18, 2000; which is a continuation-in-part of to U.S. patent application Ser. No. 09/448,822, filed Nov. 24, 1999, which issued as U.S. Pat. No. 6,321,212; which claims the benefit, under 35 U.S.C. §119(e), of U.S. Provisional Patent Application Ser. No. 60/144,890, filed Jul. 21, 1999. Further, this application is related to U.S. patent application Ser. No. 12/905,558, filed on Oct. 15, 2010, and U.S. Provisional Patent Application Ser. No. 61/353,712, filed Jun. 11, 2010. Each of the applications referred to in this paragraph is incorporated herein by reference in its entirety.

### FIELD OF THE INVENTION

The present invention relates to a parimutuel wagering system having a user interface that displays indicative odds and receives bets from users.

### BACKGROUND INFORMATION

In parimutuel betting systems, unlike other win/lose wagering systems, such as fixed-odds betting, a payout on a bet is not determined until a pool is closed, which typically occurs when or shortly before the event on which bets are placed begins. Parimutuel betting systems are designed around shifting odds that continuously change until a final bet on the event is placed. Each payout for each individual bet is determined as a share of all the available bet amounts in the pool. A winning wager in a parimutuel system receives a payout from the portion of the pool that is made available to pay winning wagers (as opposed to portions kept by operators (“the house”)), which payout is proportional to the ratio of the amount of money wagered by the individual to the available portions of the overall amount wagered by the winning bets.

In parimutuel betting systems, the role of and risk to the house, which may be, for example, a casino, sportsbook organization, racetrack operator, or the like, is minimized because bettors place wagers against other bettors, rather than against the house. Thus, parimutuel systems may eliminate any tangible risk for the house, allowing the house to simply take a cut of the entire betting pool without regard to the outcome of the event, such as an athletic competition, on which the wagers are placed.

A drawback of parimutuel wagering is the uncertainty of the payout. At the time the bet is placed, the bettor does not know what the exact odds and the exact payout amount of the bet will be, since the payout is proportional to the ratio of the amount of money wagered by the individual to the overall amount wagered by the winning bets, and the payout further depends on all amounts bet on the relevant event, and the amounts wagered are not final until the end of the betting period (although the period in which bets may be placed has not ended). Accordingly, parimutuel wagering systems can offer indicative odds, determined based on the assumption that no more bets will be received during the betting period. The indicative odds are not final as long as the betting period is open, but give the bettor an understanding of the current state of the odds. It is still possible, however, that a bettor will place a bet based on the indicative odds at the time of the bet, only to have the odds change before the end of the betting period. The winning bettor is awarded a payout based on the final odds, and not the indicative odds from the time the bet was placed.

Parimutuel wagering systems are commonly used in horse racing. In the past, parimutuel wagering systems have only been able to display indicative odds on win bets (i.e., betting on a particular horse to win a race) or exacta bets (i.e., betting on a particular horse to finish in first place and a particular horse to finish in second place). Using traditional methods, payouts for other types of bets, such as place bets (i.e., betting on a horse to finish in first or second place) or show bets (i.e., betting on a horse to finish in first, second, or third place) could not be determined until after the race was completed.

In a place bet, for example, traditional methods for calculating payouts combine only place bets in the place payout pool, and, even if a bet is placed on one horse to place, the payout of that bet is dependent on both placing horses. Consider a race of three horses, in which Horse 1 finishes first, Horse 2 finishes second, and Horse 3 finishes third. In the past, payouts for place bets would be calculated by first returning the bets of those who bet on Horses 1 and 2 to place. Then, the remainder of the pool (which, in this example, consists entirely of the bets on Horse 3 to place) is split in half. The first half is distributed between those who bet on Horse 1 to place, to each bettor in proportion with the amount bet by that bettor on Horse 1 to place, and the second half is likewise distributed between those who bet on Horse 2 to place, to each bettor in proportion with the amount bet by that bettor on Horse 2 to place. This distributed remainder, however, is not known until after the conclusion of the race, because it is not known which of the three horses will not place, and therefore it is not known which collection of bets will constitute the distributed remainder. The payouts for those who bet on Horse 1 to place could be different if Horse 2 is the other placing horse, than if Horse 3 is the other placing horse.

### SUMMARY OF THE INVENTION

As described in U.S. patent application Ser. No. 12/660,400 (“the '400 application”), and U.S. patent application Ser. No. 12/905,558 (“the '558 application”), each incorporated herein by reference, parimutuel wagering systems may accept a wide variety of wagers on an event, and may pool those wagers together. The '400 application describes the expression of bets as a combination of fundamental bets, which allows bets of different types to be entered into the same parimutuel pool. The fundamental bets described in the '400 application also allow the indicative odds of every bet to be calculated.

Since the indicative odds for all bets can be determined, the indicative odds for bets other than win bets or exacta bets can be determined and displayed to a user of a parimutuel wagering system in a user interface. The user interface may also be operable to receive new bets from a user. In this manner, the user of a parimutuel wagering system can consider more detailed betting information when deciding which bets to place.

According to an exemplary embodiment of the present invention, a computer-implemented wagering method comprises performing the following by at least one computer processor: calculating indicative odds of a bet recordable on an event, the indicative odds being based on an assumption that no more bets will be received, and outputting the indicative odds of the bet for display. In contrast to traditional parimutuel wagering systems, the determination of the indicative odds for each possible outcome of the event allows for the calculation and display of the payout for any type of bet placed on the event, even those bets which do not predict the winner.

In a further exemplary embodiment of the present invention, the bet specifies that the player will finish in a specified place, other than first, in the event. In a further exemplary embodiment of the present invention, the bet includes specification of a place in which the player will not finish in the event.

In a further exemplary embodiment of the present invention, the bet specifies that the player will finish in either a specified place in the event or in a higher place than the specified place in the event. In a further exemplary embodiment of the present invention, the bet specifies that the player will finish in either a specified place in the event or in a lower place than the specified place in the event. In a further exemplary embodiment of the present invention, the bet specifies that the player will finish in one of a range of places in the event.

In a further exemplary embodiment of the present invention, the bet specifies that the player will finish in third place in the event, that a second player will finish in second place in the event, and that a third player will finish in first place in the event.

In a further exemplary embodiment of the present invention, the bet specifies that at least one additional player will finish in a specified place in the event. In a further exemplary embodiment of the present invention, the bet specifies a place in which at least one additional player will not finish in the event.

In an example embodiment of the present invention, a wagering system comprises at least one computer processor configured to calculate indicative odds of a bet recordable on an event, the indicative odds being based on an assumption that no more bets will be received, and output the indicative odds of the bet for display wherein the bet specifies that a player will finish in a place other than first place.

In an example embodiment of the present invention, a non-transitive computer-readable medium has stored thereon instructions executable by a processor, the instructions which, when executed by the processor, cause the processor to perform a method, the method comprising calculating indicative odds of a bet recordable on an event, the indicative odds being based on an assumption that no more bets will be received, and outputting the indicative odds of the bet for display, wherein the bet specifies that a player will finish in a place other than first place.

In an example embodiment of the present invention, a computer processor may filter bet types according to indicative odds criteria received from a user, as described in U.S. patent application Ser. No. ______, filed ______ (attorney docket no. 12170/118), the entire contents of which is hereby incorporated herein by reference. For such filtered bet types, which may include the bet types specified throughout this document, the processor may output indicative odds as described throughout this document, e.g., in a user interface via which to receive user placed bets.

### BRIEF DESCRIPTION OF THE DRAWINGS

The accompanying drawings, which are incorporated in and from a part of the specification, illustrate embodiments of the present invention and, together with the description, serve to explain the principles of the invention.

FIG. 1 shows an exemplary embodiment of a user interface display according to an example embodiment of the present invention.

FIG. 2 shows a further exemplary embodiment of a user interface display according to an example embodiment of the present invention.

FIG. 3 is a flowchart that illustrates a method for wagering according to an example embodiment of the present invention.

FIG. 4 shows a system according to an example embodiment of the present invention.

### DETAILED DESCRIPTION

Example embodiments of the present invention are directed to one or more processors, which may be implemented using conventional processing circuits or devices or combinations thereof, e.g., a central processing unit (CPU) of a personal computer (PC) or other workstation processor. The processor(s) may execute code provided, e.g., on a hardware computer-readable medium including a memory device, to perform one or more, e.g., all, of the methods described herein, alone or in combination. The one or more processors may be embodied in a server and/or user terminal. The user terminal may be embodied, for example, as a desktop, laptop, hand-held device, personal digital assistant (PDA), television set-top Internet appliance, mobile telephone, smart phone, iPod, iPhone, iPad, etc., or as a combination of one or more thereof. The memory device may include any conventional permanent and/or temporary memory circuits or combination thereof, a non-exhaustive list of which includes random access memory (RAM), read only memory (ROM), compact disks (CD), digital versatile disk (DVD), and magnetic tape. Such devices may be used, for example, for placing wagers, receiving wagers, allocating wagers, and/or allocating payouts for wagers.

An example embodiment of the present invention is directed to one or more hardware computer-readable media, e.g., as described above, having stored thereon instructions executable by a processor to perform various ones of the methods described herein, alone or in combination.

An example embodiment of the present invention is directed to a method, e.g., of a hardware component or machine, including transmitting instructions executable by a processor to perform various ones of the methods described herein, alone or in combination.

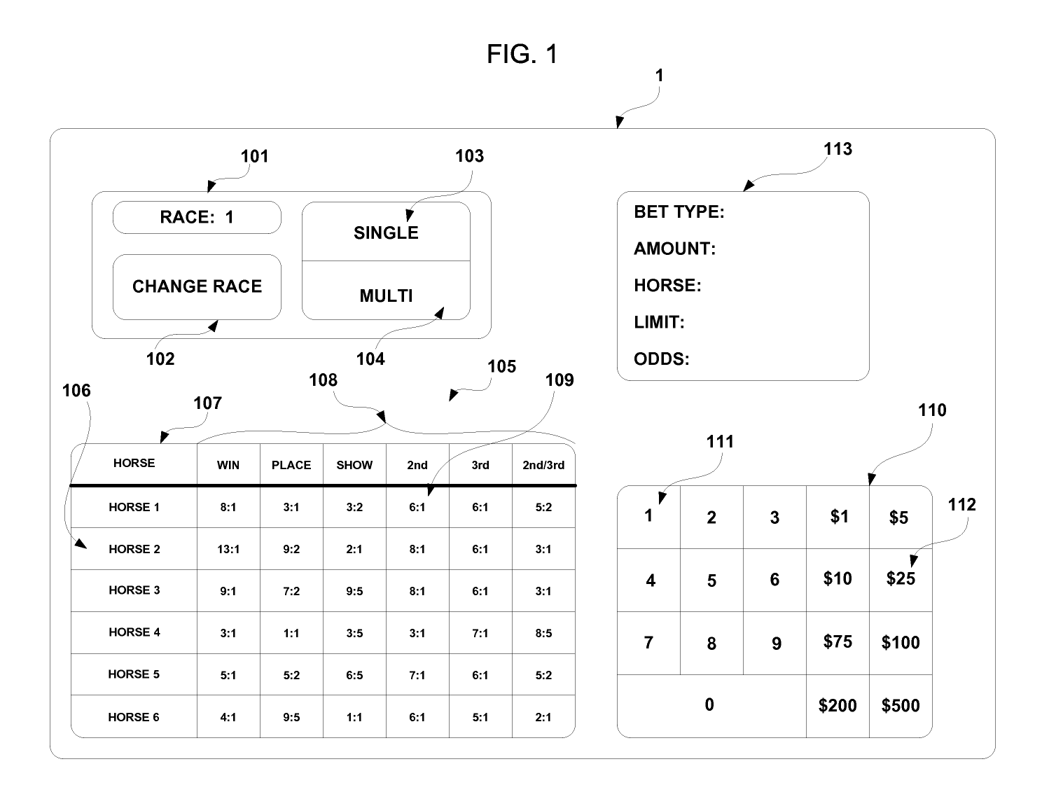

FIG. 1 shows a user interface display 1 of a graphical user interface (GUI) provided by a processor for output on a display device according to an example embodiment of the present invention, in the context of parimutuel wagering systems for horse races. While the example interface of FIG. 1 refers to a horse race, other events in which participants place in an order from first to last place are also contemplated.

The user interface display 1 may include selectable icons for communicating information to the user, or receiving the user's desired bets. For each of the selectable icons described below, responsive to selection of the respective selectable icon, a processor may change the color of the respective selectable icon when selected, so as to indicate its selection. User interface display 1 may include a race display 101, for indicating the race for which the user interface display 1 is displaying information. Race display 101 may include a selectable race change icon 102 that a user may select in order to change to a different race.

Race display 101 may further include a selectable single horse icon 103 and a selectable multi-horse icon 104. Selection of the single horse icon 103 will allow the user to make bets on a single horse to finish in a particular place in the race. When the single horse icon 103 is selected, betting grid 105 is displayed on the user interface display 1. Betting grid 105 includes horse rows 106, each row associated with a horse running in the selected race. Each horse row 106 is identified with the name of the associated horse in the horse column 107. The betting grid 105 further includes columns associated with different bet types. Each bet type column 108 contains a selectable bet icon 109 for selecting the bet type identified at the top of each bet type column 108 for the horse associated with the horse row 106.

As shown in FIG. 1, horses 1 through 6 are listed in the betting grid 105. Bet type columns 108 show possible bets on each horse, including win, place, show, second (i.e., the horse finishes in second place), third (i.e., the horse finishes in third place), and second or third (i.e., the horse finishes in second or third place). Many other bet types may be included in the bet type columns, including finishing in a specific place in the race, not finishing in a specific place in the race, finishing in a better place than a specific place in the race, finishing in a worse place than a specific place in the race, or finishing in a range of places in the race. To place a bet on Horse 1 to win, the user may select the selectable bet icon 109 corresponding to the first horse row 106 and the “win” bet type column 108.

As further shown in FIG. 1, the indicative odds for each bet, associated with each bet icon 109, may be calculated according to the exemplary embodiment of the present method, and output on user interface display 1. The indicative odds for each bet may be displayed in the selectable bet icon 109, so that the user may be made aware of the indicative odds for that particular bet. Further, the indicative odds may be updated in real-time without the user refreshing the display page in which the icons and associated indicative odds are displayed, so that the user has the most current information to consider. For example, FIG. 1 shows bet icons 109 for selecting bets that Horse 1 will win, place, show, finish second, finish third, or finish either second or third in the race. Those icons may further have displayed therein, respectively, the odds for Horse 1 to win, place, show, finish second, finish third, or finish either second or third in the race, on which information the user may base a decision to select one (or more) of the bet types to which the icons correspond for placing a bet on the respective bet type.

In an example embodiment, the user interface display 1 may include, as shown in FIG. 1, a bet amount interface 110. Bet amount interface 110 may include selectable icons in a numerical keypad 111, for entry of a user's bet amount. Further, bet amount icon 110 may include selectable bet amount icons 112 corresponding to a plurality of commonly placed bet amounts, e.g., $1, $5, $10, $25, $50, $75, $100, $200, $500, and to “other amount” (not shown). Any of the icons corresponding to the commonly placed bet amounts may be selected for causing the processor to record a bet of the respective amount on the selected bet type. Responsive to selection of the “other amount” icon, the system may display the keypad 111 in place of or in addition to the display of the icons corresponding to the plurality of commonly placed bet amounts. Alternatively, the keypad may be provided even without selection of an “other amount” icon. The selectable bet amount icons 112 provide the user with a convenient interface for entering the desired bet amount.

In an example embodiment of the present invention, the user interface 1 may further include a current bet display 113 that summarizes the user selections and provides information regarding the selections made by the user, e.g., via interaction with the user interface display 1. For example, if the user has selected Horse 1 to win, the current bet display 113 may display an identification of the selected horse, the selected bet type, the selected amount of the bet, and the most current indicative odds for the bet, which may be updated in real-time. Current bet display 113 may further display limit odds. Limit odds, as described in the '400 application, represents the limit for the final odds, once the betting period has closed, that the bettor will accept.

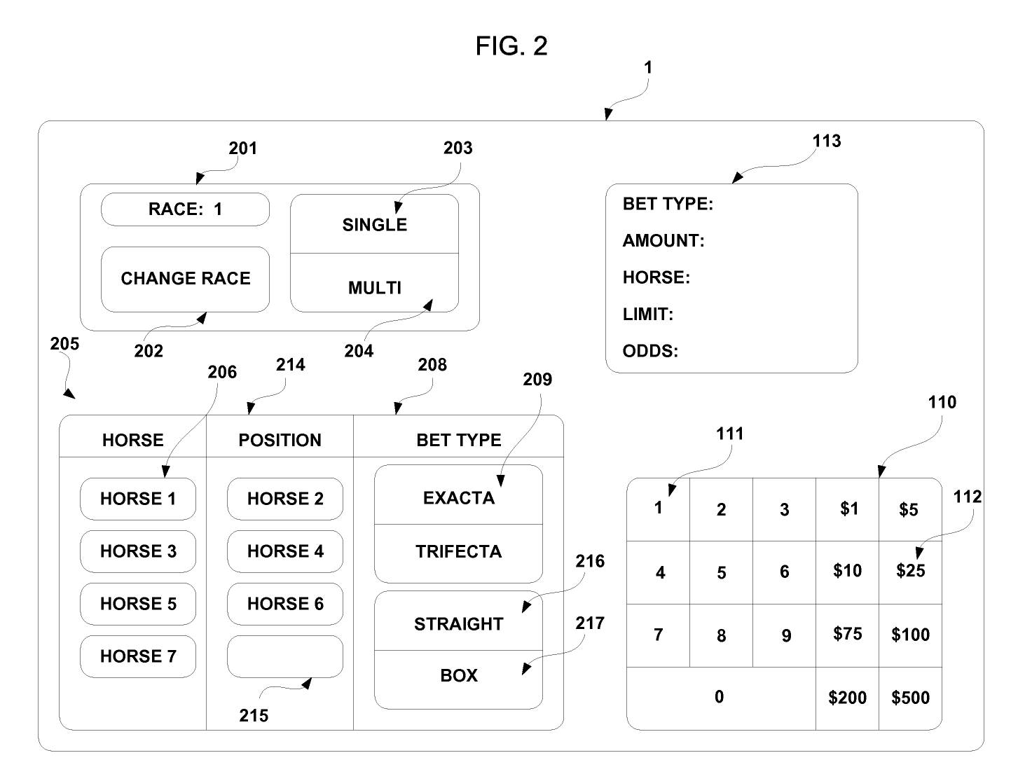

FIG. 2 shows a user interface display 1 according to an example embodiment of the present invention, in the context of parimutuel wagering systems for horse races, including race display 201 having selectable single horse icon 203 and selectable multi-horse icon 204. While the example interface of FIG. 2 refers to a horse race, other events in which participants place in an order from first to last places are also contemplated. In FIG. 2, multi-horse icon 204 has been selected, and therefore the betting grid 205 displays a different set of possible bets than that displayed in the betting grid 105 of FIG. 1. Multi-horse bets include exacta bets, trifecta bets (i.e., a particular horse finishes in first place, a particular horse finishes in second place, and a particular horse finishes in third place), or any other bet in which the user wagers on the finish of more than one horse.

In the multi-horse format shown in FIG. 2, betting grid 205 may include selectable horse icons 206 representing each horse in the selected race. Betting grid 205 may further include position column 214, having slots 215. To designate the order in which the user wants to wager the horses will finish, the user may select a horse icon 206, and then select a slot 215 in the position column 214. The horse icon 206 will then fill the slot 215, indicating that the horse associated with the horse icon 206 will finish in the slot 215, in relation to the other horses filling the remaining slots 215 in the position column 214. Betting grid 205 may also include a bet type column 208, which includes a list of selectable bet icons 209 for selecting a type of bet, such as an exacta or a trifecta. The bet type may also be modified to be straight (i.e., the horses must finish in an exact order for the bet to win), or boxed (i.e., the horses may finish in any order for the bet to win), using selectable straight icon 216 and selectable box icon 217. Once a bet has been designated using betting grid 205, the indicative odds for the designated bet are calculated and output on the current bet display 113.

Depending on the amounts being wagered on a particular event, the indicative odds on a particular event may change rapidly. Accordingly, in an example embodiment of the present invention, the system may update in real-time the display 1 of FIGS. 1 and 2, in response to changes in the indicative odds, e.g., without requiring the user to refresh the display. In this manner, the user will be able to consider the most current information in deciding how to bet.

While certain interface components are described with respect to the different example displays of FIGS. 1 and 2, other combinations of the described components may be provided. For example, the bet amount interface 110 of FIG. 1 and/or the current bet display 113 may be included in the display of FIG. 2.

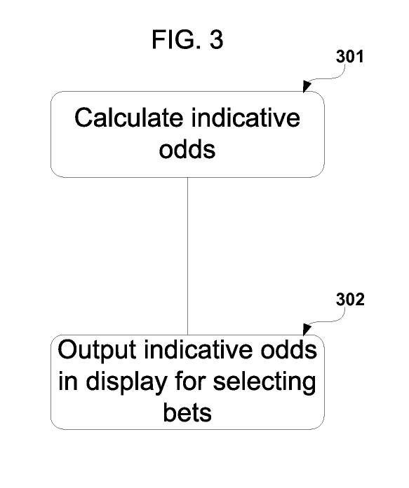

FIG. 3 is a flowchart that illustrates a method for wagering according to an example embodiment of the present invention. As shown in FIG. 3, the exemplary method begins at step 301, with at least one computer processor, which is configured to receive bets recordable on an event, calculating indicative odds of a bet, the indicative odds being based on an assumption that no more bets will be received during the betting period. Once the indicative odds of the bet are calculated, the method proceeds to step 302, with the at least one computer processor outputting the indicative odds of the bet on a user interface page, the user interface page including user-selectable controls for placing bets.

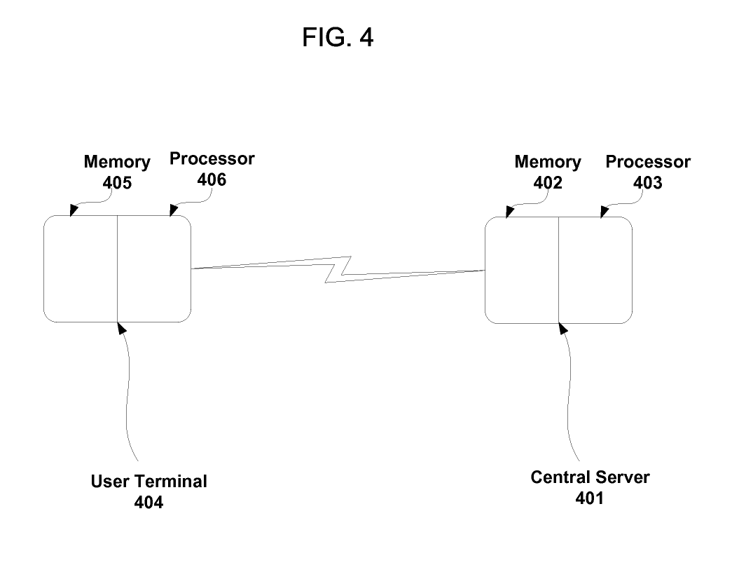

FIG. 4 shows a system according to an example embodiment of the present invention. The system of FIG. 4 includes at least one central server 401, capable of recording bets placed on one or more underlying events. Central server 401 includes memory 402 for recording the bets placed on one or more underlying events. The memory 402 may include any conventional permanent and/or temporary memory circuits or combination thereof, a non-exhaustive list of which includes random access memory (RAM), read only memory (ROM), compact disks (CD), digital versatile disk (DVD), and magnetic tape. Central server 401 further includes at least one computer processor 403, and memory 402 may store instructions executable by processor 403 for providing the user interfaces described in FIGS. 1 and 2, and for communicating with at least one user terminal 404.

At least one user terminal 404, further included in the system, may be any type of human-machine interface known in the art, including a personal computer, a laptop computer, a hand-held or portable device such as a PDA, cellular telephone, smartphone, iPod, iPhone, iPad, etc. User terminal 404 includes memory 405, which may also include any conventional permanent and/or temporary memory circuits or combination thereof, a non-exhaustive list of which includes random access memory (RAM), read only memory (ROM), compact disks (CD), digital versatile disk (DVD), and magnetic tape. User terminal 404 may further include at least one computer processor 406. Memory 405 of user terminal 403 may store instructions executable by processor 406 for providing the user interfaces described in FIGS. 1 and 2, and for communicating with the central server 401. The communication between user terminal 404 and central server 401 may include updates of information for outputting indicative odds and for placing bets.

Either of processors 403 and 406 may perform any of the method steps of the present invention. Processor 403 of central server 401 may calculate indicative odds, for example, and communicate the determined indicative odds to the user terminal 404. Processor 406 of user terminal 404 may, for example, communicate the bets placed by the user to the central server 401.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A computer-implemented wagering method, comprising:
performing the following by at least one computer processor:
calculating indicative odds of a bet recordable on an event, the indicative odds being based on an assumption that no more bets will be received; and
outputting the indicative odds of the bet for display;
wherein the bet specifies that a player will finish in a place other than first place.

2. The method of claim 1, wherein the bet identifies the place in which the player will finish in the event.

3. The method of claim 1, wherein the bet specifies a place in which the player will not finish in the event.

4. The method of claim 1, wherein the bet specifies that the player will finish in either a specified place in the event or in a higher place than the specified place in the event.

5. The method of claim 1, wherein the bet specifies that the player will finish in either a specified place in the event or in a lower place than the specified place in the event.

6. The method of claim 1, wherein the bet specifies that the player will finish in one of a range of places in the event.

7. The method of claim 1, wherein the bet specifies that the player will finish in third place in the event, that a second player will finish in second place in the event, and that a third player will finish in first place in the event.

8. The method of claim 1, wherein the bet specifies that at least one additional player will finish in a specified place in the event.

9. The method of claim 1, wherein the bet specifies a place in which at least one additional player will not finish in the event.

10. A wagering system, comprising:
at least one computer processor configured to:
calculate indicative odds of a bet recordable on an event, the indicative odds being based on an assumption that no more bets will be received; and
output the indicative odds of the bet for display;
wherein the bet specifies that a player will finish in a place other than first place.

11. A non-transitive computer-readable medium having stored thereon instructions executable by a processor, the instructions which, when executed by the processor, cause the processor to perform a method, the method comprising:
calculating indicative odds of a bet recordable on an event, the indicative odds being based on an assumption that no more bets will be received; and
outputting the indicative odds of the bet for display;
wherein the bet specifies that a player will finish in a place other than first place.
